(19) United States
(12) Patent Application Publication
(10) Pub. No.: US 2005/0010915 A1
(43) Pub. Date: Jan. 13, 2005

(54) Network-based server code auto upgrade method and system

(76) Inventor: Chih-Wei Chen, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/618,883

(22) Filed: Jul. 11, 2003

(51) Int. Cl. G06F 9/44

(52) U.S. Cl. 717/170; 717/171; 717/176

(57) ABSTRACT

A network-based server code auto upgrade method and system is proposed, which is designed for use with a network system, such as intranet, extranet, or Internet, that is linked to a cluster of servers of the same type for the purpose of upgrading the server code in each of the servers in an automatic manner to a new version of server code via the network system. Compared to old practice, the proposed auto upgrade method and system allows a cluster of servers of the same type to be upgraded automatically one by one via the network system without requiring network system management personnel to manually install the new version of server code into each of the servers one by one so as to help allow network management more efficient

### BACKGROUND OF THE INVENTION

1. Field of the Invention

This invention relates to network-based information technology, and more particularly, to a network-based server code auto upgrade method and system, which is designed for use with a network system linked to a cluster of servers of the same type (i.e., a group of servers that are installed with the same code including operating system and applications to offer the same server functionality) for the purpose of upgrading the server code in each of the servers in an automatic manner.

2. Description of Related Art

Network-based information technology is widely utilized in large corporations for exchange of business data and messages among various divisions and staff members via a network system such as intranet, extranet, or Internet. Typically, the network system of a corporation is linked to a number of various types of servers, with each server type offering a specific server function, such as file servers, data storage servers, email servers, proxy servers, and so on. Each server type typically includes a number of separate and independent servers distributed at different locations so that users can gain access to a specific server function by linking to any one of these servers.

In the network system, a server is typically installed with a number of various kinds of computer programs, including, for example, BIOS (Basic Input/Output System), firmware control code, server management programs, embedded operating system, application programs, and so on. These server-based computer programs are hereinafter collectively referred to as “server code” in this specification. Normally, if a cluster of servers are used to offer the same server function, these servers are installed with exactly the same server code, including BIOS, firmware control code, server management programs, embedded operating system, and application programs.

When a new version of server code is released, it is required to upgrade all the servers in the network system that are installed with the old version of the new server code. Traditionally, the upgrade is done by network system management personnel through manually installing the new version of server code into each of the servers one by one. This practice is undoubtedly quite laborious and time-consuming and therefore is quite inefficient to network management.

### SUMMARY OF THE INVENTION

It is therefore the primary objective of this invention to provide a network-based server code auto upgrade method and system that is capable of automatically performing a remote upgrade procedure on a cluster of servers of the same type without requiring network system management personnel to manually install the new version of server code into each of the servers one by one so as to help allow network management more efficient.

The network-based server code auto upgrade method and system is characterized by the functions of linking via the network system to each of the servers; then inspecting the current version of server code installed in each of the servers via the network system; and then comparing the current version of server code installed in each of the servers against the version of the new server code; and in the event that the current version of server code installed in any one of the servers is older than the version of the new server code, performing a remote upgrade procedure on that server via the network system to replace the current version of server code in that server with the new version of server code.

Compared to the old practice, the network-based server code auto upgrade method and system of the invention allows a cluster of servers of the same type to be upgraded automatically one by one via the network system without requiring network system management personnel to manually install the new version of server code into each of the servers one by one so as to help allow network management more efficient.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing an object-oriented component model of the network-based server code auto upgrade system according to the invention; and

FIG. 2 is a flow diagram showing the operational procedures performed by the network-based server code auto upgrade method and system according to the invention.

### DETAILED DESCRIPTION OF PREFERRED EMBODIMENTS

The network-based server code auto upgrade method and system according to the invention is disclosed in full details by way of preferred embodiments in the following with reference to the accompanying drawings.

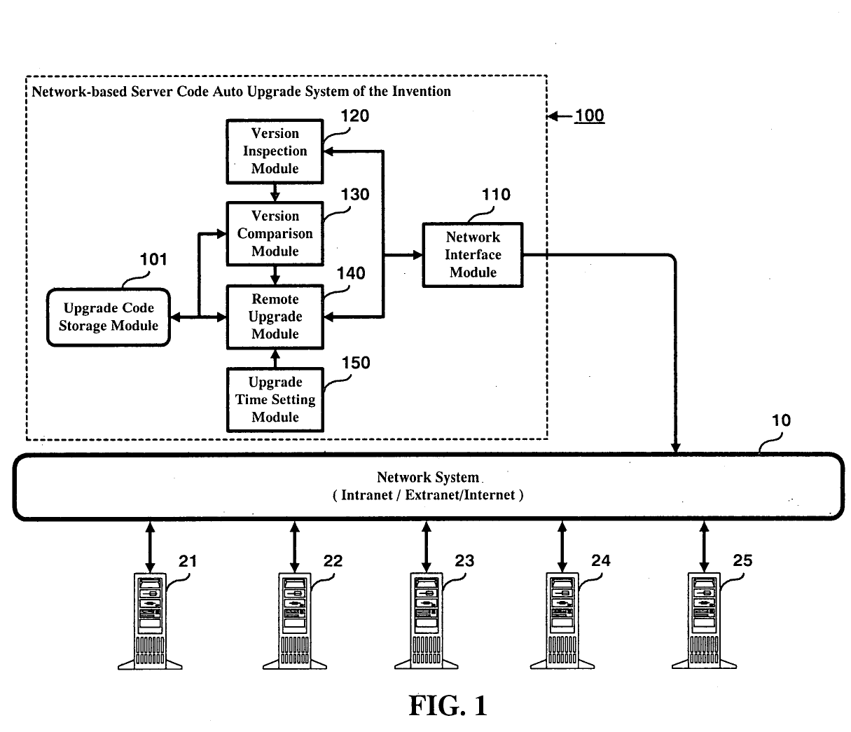

FIG. 1 is a schematic diagram showing the object-oriented component model of the network-based server code auto upgrade system (as the part enclosed in the dotted box indicated by the reference numeral 100). As shown, in practical application, the network-based server code auto upgrade system of the invention 100 is linked to a network system 10, such as an intranet system, an extranet system, or the Internet, which is linked to a cluster of servers of the same type, for example 5 servers 21, 22, 23, 24, 25 that are used to offer the same server functionality, such as file servers, data storage servers, email servers, or proxy servers. These servers 21, 22, 23, 24, 25 are installed with exactly the same server code. When a new version of server code is released, the network-based server code auto upgrade system of the invention 100 is capable of upgrading the old version of server code in each of thee servers 21, 22, 23, 24, 25 in an automatic manner. It is to be noted that the example of FIG. 1 shows only 5 servers, but the invention is applicable to any number of servers.

In practice, the network-based server code auto upgrade system of the invention 100 can be implemented by software and installed either on an independent server (called upgrade platform) or on any one of the servers 21, 22, 23, 24, 25. The object-oriented component model of the network-based server code auto upgrade system of the invention 100 comprises the following components: (a) an upgrade code storage module 101; (b) a network interface module 110; (c) a version inspection module 120; (d) a version comparison module 130; and (e) a remote upgrade module 140; and can further optionally include an upgrade time setting module 150.

With the invention, network system management personnel needs just to download a new version of server code into the upgrade code storage module 101, and the network-based server code auto upgrade system of the invention 100 will be automatically activated to upgrade the old version of server code in each of the servers 21, 22, 23, 24, 25 remotely via the network system 10.

The upgrade code storage module 101 is, for example, a hard disk module, a flash memory module, or any type of data storage media, which is used to store a new version of server code, including, for example, BIOS, firmware control code, server management programs, embedded operating system, application programs, and so on.

The network interface module 110 is linked to the network system 10, which allows the network-based server code auto upgrade system of the invention 100 to be linked via the network system 10 to any one of the servers 21, 22, 23, 24, 25 so as to allow the version inspection module 120 and the remote upgrade module 140 to exchange message or download code via the network system 10 to any one of the servers 21, 22, 23, 24, 25.

The version inspection module 120 is capable of inspecting the current version of server code in each of the servers 21, 22, 23, 24, 25 through the network interface module 110 and via the network system 10, such as by inspecting the current version or serial number embedded in the server code installed in each of the servers 21, 22, 23, 24, 25. The obtained version information is then transferred to the version comparison module 130.

The version comparison module 130 is capable of comparing the current version of server code in each of the servers 21, 22, 23, 24, 25 against the version of the new server code stored in the upgrade code storage module 101. If the current version of server code in any one of the servers 21, 22, 23, 24, 25 is older than the version of the new server code stored in the upgrade code storage module 101, the version comparison module 130 will issue an upgrade-enable message to the remote upgrade module 140.

The remote upgrade module 140 is capable of, in response to the upgrade-enable message from the version comparison module 130, performing a remote upgrade procedure on the servers 21, 22, 23, 24, 25 via the network system 10, wherein the new version of server code stored in the upgrade code storage module 101 is downloaded via the network system 10 to each of the servers 21, 22, 23, 24, 25, and the downloaded code is used to replace the current version of server code in each of the servers 21, 22, 23, 24, 25.

The upgrade time setting module 150 is an optional module, which allows the user to specify a particular time, for example 3:00 AM, for the remote upgrade module 140 to perform the remote upgrade procedure at the user-specified time. If this upgrade time setting module 150 is not provided, the remote upgrade module 140 can be preset in the design phase to perform the remote upgrade procedure at a designer-specified time.

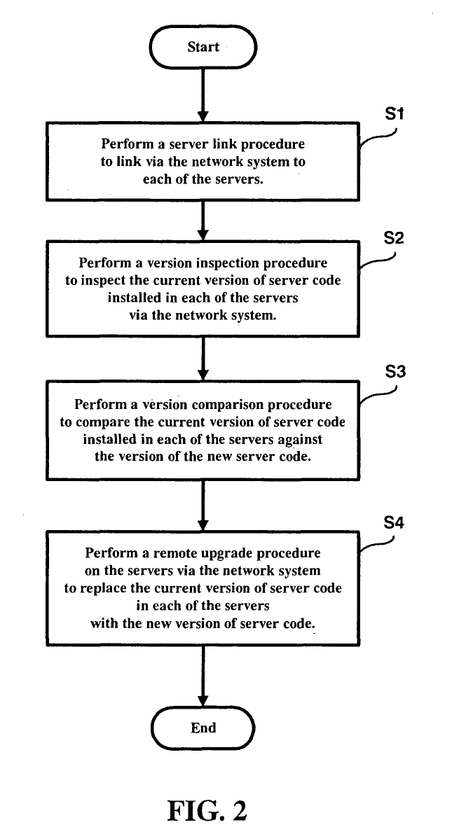

FIG. 2 is a flow diagram showing the operational procedures performed by the network-based server code auto upgrade system of the invention 100 for performing an automatic remote upgrade procedure on the servers 21, 22, 23, 24, 25 via the network system 10 when a new version of server code is available.

Referring to FIG. 2 together with FIG. 1, the first step S1 is to perform a server link procedure, wherein the network interface module 110 is activated to link the network-based server code auto upgrade system of the invention 100 via the network system 10 to each of the servers 21, 22, 23, 24, 25.

In the next step S2, a version inspection procedure is performed, wherein the version inspection module 120 is activated to inspect the current version of server code installed in each of the servers 21, 22, 23, 24, 25, such as to inspect the current version or serial number embedded in the server code, and then transfer the obtained version information to the version comparison module 130.

In the next step S3, a version comparison procedure is performed, wherein the version comparison module 130 is activated to compare the current version of server code installed in each of the servers 21, 22, 23, 24, 25 against the version of the new server code stored in the upgrade code storage module 101. If the current version of server code in any one of the servers 21, 22, 23, 24, 25 is older than the version of the new server code stored in the upgrade code storage module 101, the version comparison module 130 will issue an upgrade-enable message to the remote upgrade module 140.

In the next step S4, a remote upgrade procedure is performed, wherein the remote upgrade module 140 is activated in response to the upgrade-enable message from the version comparison module 130 to perform a remote upgrade procedure on the servers 21, 22, 23, 24, 25 via the network system 10. During this remote upgrade procedure, the remote upgrade module 140 downloads the new version of server code stored in the storage module 101 through the network interface module 110 and via the network system 10 to each of the servers 21, 22, 23, 24, 25, and the downloaded server code is used to replace the old version of server code in each of the servers 21, 22, 23, 24, 25.

In conclusion, the invention provides a network-based server code auto upgrade method and system designed for use with a network system linked to a cluster of servers of the same type for the purpose of upgrading the server code in each of the servers in an automatic manner. Compared to the old practice, the network-based server code auto upgrade method and system of the invention allows a cluster of servers of the same type to be upgraded automatically one by one via the network system without requiring network system management personnel to manually install the new version of server code into each of the servers one by one so as to help allow network management more efficient. The invention is therefore highly advantageous to use.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A network-based server code auto upgrade method for use on a network system linked to a cluster of servers of the same type for upgrading the current version of server code in each of the servers to a new version of server code;
the network-based server code auto upgrade method comprising:
linking via the network system to each of the servers;
inspecting the current version of server code installed in each of the servers via the network system;
comparing the current version of server code installed in each of the servers against the version of the new server code;
in the event that the current version of server code installed in any one of the servers is older than the version of the new server code, performing a remote upgrade procedure on that server via the network system to replace the current version of server code in that server with the new version of server code.

2. The network-based server code auto upgrade method of claim 1, wherein the network system is selected from the group comprising: intranet, extranet, and Internet.

3. The network-based server code auto upgrade method of claim 1, wherein the servers are selected from the group of types comprising: file servers, data storage servers, email servers, and proxy servers.

4. The network-based server code auto upgrade method of claim 1, wherein the new version of server code is selected from the group comprising: BIOS, firmware control code, server management programs, embedded operating system, and application programs.

5. The network-based server code auto upgrade method of claim 1, wherein the remote upgrade procedure is carried out at a user-specified time.

6. A network-based server code auto upgrade system for use with a network system linked to a cluster of servers of the same type for upgrading the current version of server code in each of the servers to a new version of server code;
the network-based server code auto upgrade system comprising:
an upgrade code storage module for storing the new version of server code;
a network interface module for linking via the network system to each of the servers;
a version inspection module for inspecting the current version of server code installed in each of the servers through the network interface module and via the network system;
a version comparison module, which is capable of comparing the current version of server code installed in each of the servers against the version of the new server code stored in the upgrade code storage module, and which is capable of issuing an upgrade-enable message if the current version of server code installed in any one of the servers is older than the version of the new server code stored in the upgrade code storage module; and
a remote upgrade module, which is capable of being activated in response to the upgrade-enable message from the version comparison module to perform a remote upgrade procedure on that server via the network system to replace the current version of server code in that server with the new version of server code stored in the upgrade code storage module.

7. The network-based server code auto upgrade system of claim 6, wherein the network system is selected from the group comprising: intranet, extranet, and Internet.

8. The network-based server code auto upgrade system of claim 6, wherein the servers are selected from the group of types comprising: file servers, data storage servers, email servers, and proxy servers.

9. The network-based server code auto upgrade system of claim 6, wherein the new version of server code is selected from the group comprising: BIOS, firmware control code, server management programs, embedded operating system, and application programs.

10. The network-based server code auto upgrade system of claim 6, further comprising:
an upgrade time setting module for user to specify a time point for the remote upgrade module to perform the remote upgrade procedure at the user-specified time.
